(19) United States
(12) Patent Application Publication
(10) Pub. No.: US 2025/0239247 A1
(43) Pub. Date: Jul. 24, 2025

(54) ACOUSTIC ABSORPTION STRUCTURE COMPRISING A CELLULAR STRUCTURE AND AT LEAST ONE PARTITION TUBE WHICH HAS AT LEAST TWO FLAT SIDES WHICH ARE CONNECTED TO THE WALLS OF THE CELLULAR STRUCTURE

(71) Applicant: Airbus Operations (S.A.S.), Toulouse (FR)

(72) Inventors: Arnaud Bourhis, Toulouse (FR); Benoit Przybyla, Toulouse (FR)

(21) Appl. No.: 19/034,758

(22) Filed: Jan. 23, 2025

(30) Foreign Application Priority Data
Jan. 24, 2024 (FR) FR2400682

(51) Int. Cl. G10K 11/172; G10K 11/20

(52) U.S. Cl. CPC G10K 11/172; G10K 11/20; G10K 2210/3219; G10K 2210/32272

(57) ABSTRACT

An acoustic absorption structure includes at least one cellular structure interposed between an acoustically resistive layer and a reflective layer, which includes cells and at least one partition tube positioned in one of the cells and configured to delimit in the cell two cavities forming two resonators. The partition tube includes at least two flat sides, the walls which delimit the cell into which the partition tube is inserted including at least first and second planar fixing walls against which the flat sides of the partition tube are placed and fixed, and at least two remote walls which are spaced apart from the lateral wall of the partition tube.

### TECHNICAL FIELD

The present application relates to an acoustic absorption structure comprising a cellular structure and at least one partition tube which has at least two flat sides which are connected to the walls of the cellular structure.

### BACKGROUND

According to an embodiment of the prior art, an aircraft propulsion assembly comprises a nacelle and a double-flow turbomachine which is positioned inside the nacelle and which has, at the rear, a primary exhaust duct via which the combusted gases which are produced as a result of the combustion are discharged. This primary exhaust duct comprises, in the region of its skin, an acoustic absorption structure in order to attenuate the noise on several frequency bands, such as for example the noises associated with the combustion (300-1000 Hz) and the noises associated with the operation of the turbine (greater than or equal to 4000 Hz).

According to a first embodiment, an acoustic absorption structure comprises at least one cellular structure which is positioned between a layer, which is acoustically resistive, in contact with a center in which the acoustic waves are propagated, and a reflective layer. This embodiment makes it possible to obtain a quarter-wave resonator which is capable of attenuating sound waves with high frequencies. According to this embodiment, the range of frequencies of the attenuated sound waves depends on the height of the cells of the cellular structure.

According to a second embodiment, which is visible in FIG. 1 and described in the document FR 094668, an acoustic absorption structure 10 comprises first and second cellular structures 12, 14 which are positioned between a resistive acoustic layer 16 in contact with a center in which acoustic waves are propagated, and a reflective layer 18. This acoustic absorption structure 10 comprises a separation layer 20 which is interposed between the first and second cellular structures 12, 14, the first cellular structure 12 being interposed between the acoustically resistive layer 16 and the separation layer 20 and the second cellular structure 14 being interposed between the reflective layer 18 and the separation layer 20.

According to this second embodiment, the separation layer 20 comprises orifices 22 which allow the cells of the first cellular structure 12 to communicate with those of the second cellular structure 14, each orifice 22 being extended by a tube 24 positioned in the second cellular structure 14.

The acoustic absorption structure 10 makes it possible to obtain two types of resonators, namely a first resonator of the Helmholtz type in the region of the cells of the first cellular structure 12, which is capable of attenuating the low-frequency sound waves, and a second resonator of the quarter-wave type in the region of the cells of the second cellular structure 14, which is capable of attenuating the high-frequency sound waves.

According to this second embodiment, each tube 24 is connected by a connection 24.1 to the separation layer and then the first and second cellular structures 12, 14 are connected by connections 12.1, 14.1 to the separation layer 20. The cells of the first and second cellular structures 12, 14 have to be perfectly aligned so that each cell of the first cellular structure 12 communicates only with a single cell of the second cellular structure 14.

While this second embodiment makes it possible to attenuate the sound waves over wider frequency ranges, it is not entirely satisfactory since the high number of connections results in the mass of the acoustic absorption structure 10 being increased and the manufacturing method thereof being complicated. This manufacturing method is all the more complicated to implement due to the cells of the first and second cellular structures having to be perfectly aligned in order to obtain optimal operation. According to a further drawback, such an acoustic absorption structure requires at least two drainage systems, one for each of the first and second cellular structures 12, 14, which tends to complicate the acoustic absorption structure. Finally, the shaping according to a curved profile of the acoustic absorption structure 10 proves difficult, taking into account the connections 12.1, 14.1 which connect the ends of the walls delimiting the cells of the first and second cellular walls 12, 14 with the separation layer 20.

### SUMMARY

The disclosure herein aims to remedy all or some of the drawbacks of the prior art. To this end, the subject of the disclosure herein is an acoustic absorption structure comprising at least one cellular structure which is interposed between an acoustically resistive layer and a reflective layer, the cellular structure comprising a first face in contact with the acoustically resistive layer, a second face in contact with the reflective layer and a plurality of cells, each leading to the region of the first and second faces, and each cell being delimited by walls.

According to the disclosure herein, the cellular structure comprises at least one partition tube, which is positioned in one of the cells, comprising a first tube section which extends between the first and second ends and has a first section between the first and second ends, and a second tube section which extends between the first and second ends and has a second section between the first and second ends, the second section being smaller than the first section and a joining wall connecting the second ends of the first and second tube sections; the first end of the first tube section being sealed by a first layer, from either the acoustically resistive layer or the reflective layer, and the first end of the second tube section being spaced apart from a second layer, which is different from the first layer, from either the acoustically resistive layer or the reflective layer. In addition, the first tube section of the partition tube comprises at least two flat sides and at least one lateral wall, the walls which delimit the cell into which the partition tube is inserted comprising at least first and second planar fixing walls against which the flat sides of the partition tube are placed and fixed, and at least two remote walls which are spaced apart from the lateral wall of the partition tube.

This solution makes it possible to obtain a cellular structure comprising two types of resonators which are configured to attenuate sound waves on a wide frequency band or on several frequency bands. Providing a partition tube which comprises at least two flat sides which are fixed against the first and second planar walls of the cell makes it possible to simplify the fixing of the partition tube, provides a greater resistance to the connection connecting the partition tube and the cellular structure and permits the cellular structure to preserve a certain degree of flexibility so that it can be shaped.

According to a further feature, the acoustic absorption structure comprises at least one first drainage network which comprises first and second openings passing through the first and second fixing walls and at least one second drainage network which comprises third and fourth openings passing through third and fourth walls opposing the first and second fixing walls.

According to a further feature, each wall of the cell in which the partition tube is positioned comprises first and second end edges located in the region of the first and second faces of the cellular structure. In addition, the first, second, third and fourth openings are located in the region of the first or second end edges of the walls, the first end of the first tube section of the partition tube being positioned in the region thereof.

According to a further feature, the partition tube comprises at least one notch which extends from the first end of the first tube section, the notch being configured to open up at least the first and second openings when the partition tube is fixed to the first and second fixing walls.

According to a further feature, the partition tube comprises a single notch which opens up the first and second openings. According to a further feature, the notch is delimited by a first edge and second and third edges, connecting the first edge and the upper end of the first tube section, remote from the lateral wall.

According to a further feature, the first and second fixing walls are connected by a common lateral edge, the partition tube comprising a spacer zone, separating the two flat sides, spaced apart from the lateral edge which is common to the first and second fixing walls.

According to a further feature, each flat side extends from the first end to the second end of the first tube section.

According to a further feature, the lateral wall comprises two planar parts which are parallel to one another and connected to the flat sides and a curved part connecting the two planar parts, the planar and curved parts of the lateral wall being spaced apart from the walls of the cell in which the partition tube is positioned.

According to a further feature, in a given area, each cell of the cellular structure comprises a partition tube which is connected to the first and second fixing walls which are passed through by the first and second openings and spaced apart from third and fourth walls opposing the first and second fixing walls which are passed through by third and fourth openings. In addition, the first and second fixing walls of the cells are connected to one another so as to form, when viewed from above, at least one first broken line, the partition tubes being positioned on either side of the first broken line and connected to the first and second fixing walls, and the third and fourth walls of the cells being connected to one another so as to form, when viewed from above, at least one second broken line which is spaced apart from the first broken line.

### BRIEF DESCRIPTION OF THE DRAWINGS

Further features and advantages will be found in the following description of the disclosure herein, the description being provided solely by way of example and with reference to the accompanying drawings, in which:

FIG. 1 is a schematic section of an acoustic absorption structure illustrating an embodiment of the prior art;

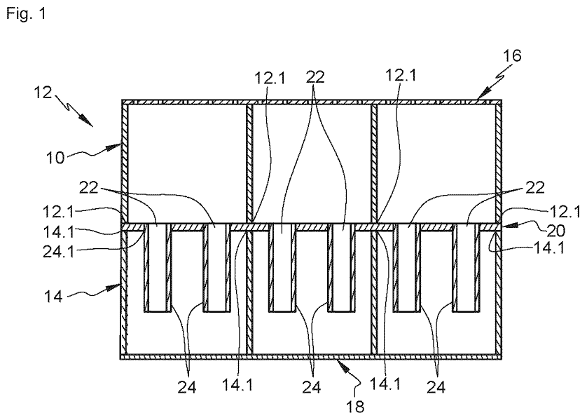

FIG. 2 is a lateral view of an aircraft;

FIG. 3 is a longitudinal section of a part of an aircraft propulsion assembly;

FIG. 4 is a longitudinal section of a part of an acoustic absorption structure illustrating an embodiment of the disclosure herein;

FIG. 5 is a longitudinal section of a part of an acoustic absorption structure illustrating a further embodiment of the disclosure herein;

FIG. 6 is a schematic view of the different steps for a method of manufacturing an acoustic absorption structure illustrating an embodiment of the disclosure herein;

FIG. 7 is a schematic view of the different steps for a method of manufacturing an acoustic absorption structure illustrating a further embodiment of the disclosure herein;

FIG. 8 is a lateral view of a partition tube without a notch illustrating an embodiment of the disclosure herein;

FIG. 9 is a perspective view of the partition tube which is visible in FIG. 8;

FIG. 10 is a view from above of the partition tube, which is visible in FIG. 8, positioned in a cell of a cellular structure illustrating an embodiment of the disclosure herein;

FIG. 11 is a lateral view of a part comprising two partition tubes illustrating an embodiment of the disclosure herein;

FIG. 12 is a lateral view of a partition tube illustrating an embodiment of the disclosure herein;

FIG. 13 is a perspective view of the partition tube which is visible in FIG. 12;

FIG. 14 is a perspective view of a cell of a cellular structure and a partition tube, before and after assembly, illustrating an embodiment of the disclosure herein;

FIG. 15 is a perspective view of a plurality of cells of a cellular structure and a plurality of partition tubes, during assembly, illustrating an embodiment of the disclosure herein; and

FIG. 16 is a perspective view of a part of a cellular structure illustrating an embodiment of the disclosure herein.

### DETAILED DESCRIPTION

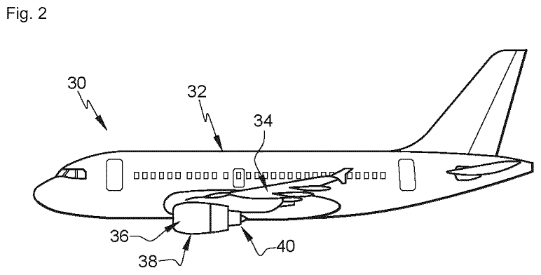

An aircraft 30 which has a fuselage 32, two wings 34 arranged on either side of the fuselage 32 and propulsion assemblies 36 fixed below the wings 34 is shown in FIG. 2. Each propulsion assembly 36 comprises a nacelle 38 and a turbomachine 40 positioned inside the nacelle 38.

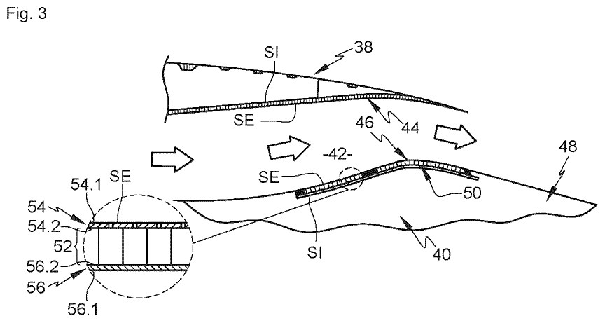

According to an embodiment which is visible in FIG. 3, the turbomachine 40 comprises at the rear a primary exhaust duct 42 via which the gases combusted in the turbomachine 40 are discharged, and which is delimited on the outside by an external wall 44 and on the inside by an internal wall 46 extended by a nozzle cone 48.

According to one configuration, the external and internal walls 44, 46 each comprise at least one acoustic absorption structure 50.

Each acoustic absorption structure 50 comprises an external surface SE in contact with a center in which the acoustic waves are propagated and an internal surface SI opposing the external surface SE.

Although described as being applicable to a primary exhaust duct 42, the disclosure herein is not limited to this application. Thus the acoustic absorption structure 50 can be positioned in the region of the walls which have an external surface SE in contact with a center in which the sound waves are propagated.

Each acoustic absorption structure 50 comprises at least one cellular structure 52 which is interposed between an acoustically resistive layer 54 which is permeable to sound waves and a reflective layer 56 which is impermeable to sound waves. The acoustically resistive layer 54 has a first face 54.1 corresponding to the external surface SE and a second face 54.2 which is oriented toward the cellular structure 52 and connected thereto. The reflective layer 56 has a first face 56.1 corresponding to the internal surface SI and a second face 56.2 which is oriented toward the cellular structure 52 and connected thereto.

The acoustically resistive layer 54, the reflective layer 56, the connection between the acoustically resistive layer 54 and the cellular structure 52 and the connection between the reflective layer 56 and the cellular structure 52 are not described in more detail since they may be identical to those of the prior art.

The cellular structure 52 extends between a first face 52.1 in contact with the acoustically resistive layer 54 and a second face 52.2 in contact with the reflective layer 56 and comprises a plurality of substantially rectangular walls 58.1 to 58.6 which each have first and second edges respectively positioned in the region of the first and second faces 52.1, 52.2. These walls 58.1 to 58.6 are connected to one another so as to delimit the cells 60 leading to the region of the first and second faces 52.1, 52.2.

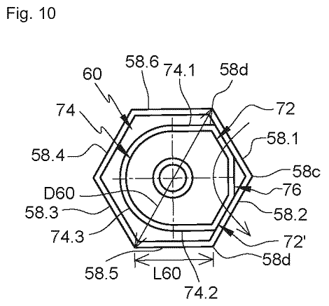

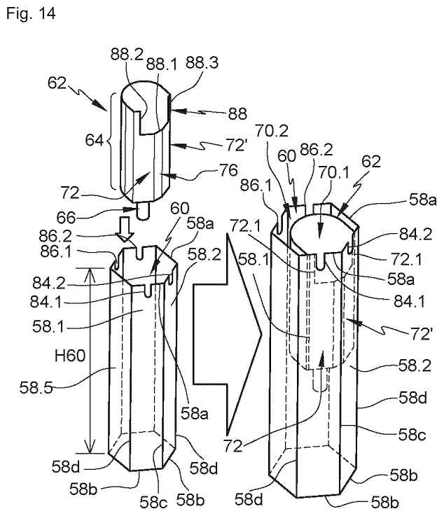

In one embodiment, the cellular structure 52 is a honeycomb structure. As illustrated in FIG. 10, each cell 60 is delimited by six walls 58.1 to 58.6 and has a hexagonal cross section with six identical sides having a width L60. Each hexagonal cell 60 comprises an inscribed circle of cell diameter D60. The cell diameter D60 is between 9.6 and 19.1 mm. Each cell 60 has a cell height H60 (visible in FIG. 14) which corresponds to the distance separating the first and second faces 52.1, 52.2. The cell height H60 is between 30 and 70 mm. Each rectangular wall 58.1 to 58.6 has a length equal to the cell height H60, of between 30 and 70 mm, and a width of between approximately 5 and 12 mm.

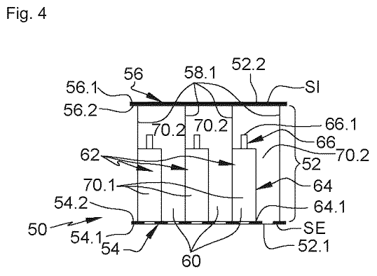

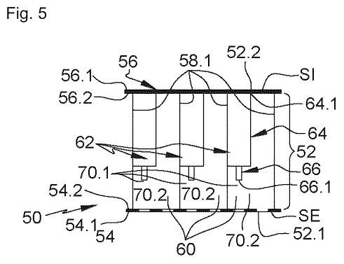

Naturally the disclosure herein is not limited to this embodiment of the cells 60. Each of the cells leads to the region of the first and second ends which are respectively sealed by the acoustically resistive layer 54 and the reflective layer 56. Each of the cells is delimited by planar walls 58.1 to 58.6 including two fixing walls 58.1, 58.2. The cellular structure 52 comprises at least one partition tube 62 which is positioned in a cell 60. According to one configuration, the cellular structure 52 comprises a plurality of partition tubes 62 which are each positioned in a cell 60. According to one arrangement, in at least one area of the cellular structure 52, this cellular structure comprises a partition tube 62 in each cell 60, as illustrated in FIGS. 4 and 5.

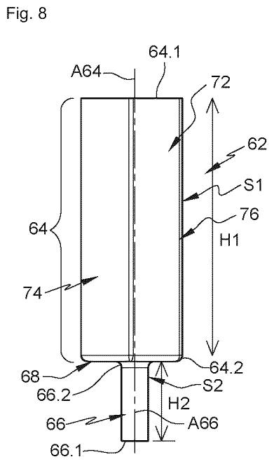

As illustrated in FIGS. 8 and 10, each partition tube 62 comprises a first tube section 64 which extends between the first and second ends 64.1, 64.2 and has a first section S1 between the first and second ends 64.1, 64.2, a second tube section 66 which extends between the first and second ends 66.1, 66.2 and has a second section S2 between the first and second ends 66.1, 66.2, the second section S2 being smaller than the first section S1, and a joining wall 68 connecting the two ends 64.2, 66.2 of the first and second tube sections 64, 66. According to one configuration, the second section S2 is less than 25% of the first section S1, preferably less than 15%.

Each partition tube 62 is produced in a single piece, the first and second tube sections 64, 66 and the joining wall 68 being produced during the same manufacturing step.

According to one embodiment, the first section S1 is uniform over a first height H1 between the first and second ends 64.1, 64.2. Thus the first tube section 64 has a first axis A64. The first height H1 is between 1 and 20 mm. According to one arrangement, the first height H1 is between 25% and 75% of the cell height H60. According to one configuration, the first height H1 is substantially equal to half of the cell height H60.

According to one embodiment, the second section S2 is uniform over a second height H2 between the first and second ends 66.1, 66.2. Thus the second tube section 66 has a second axis A66. According to one embodiment, the second section S2 is circular. According to one configuration, the second section S2 is between 0.15 mm² and 20 mm², which corresponds respectively to diameters of approximately 0.5 mm and 5 mm. The second height H2 is between 10 and 25 mm.

According to one arrangement, the first and second axes A64 and A66 are aligned.

According to one embodiment, the joining wall 68 is located in a plane perpendicular to the first axis A64, namely substantially perpendicular to the first tube section 64. Naturally, the disclosure herein is not limited to this embodiment for the joining wall 68. This wall could be non-planar and frustoconical, for example.

According to a first embodiment which is visible in FIG. 4, the first end 64.1 of the first tube section 64 is positioned in the region of the first face 52.1 of the cellular structure 52 in order to be sealed by the acoustically resistive layer 54 and connected thereto in a sealed manner. The first end 66.1 of the second tube section 66 is spaced apart from the reflective layer 56 and the second face 52.2 of the cellular structure 52 by a distance of between 0.5 mm and 70% of the cell height H60.

According to a second embodiment which is visible in FIG. 5, the first end 64.1 of the first tube section 64 is positioned in the region of the first face 52.2 of the cellular structure 52 in order to be sealed by the reflective layer 56 and connected thereto in a sealed manner. The first end 66.1 of the second tube section 66 is spaced apart from the acoustically resistive layer 54 and from the first face 52.1 of the cellular structure 52 by a distance of between 0.5 mm and 70% of the cell height H60.

Whatever the embodiment, the partition tube 62 divides the cell 60 in which it is positioned into first and second cavities 70.1, 70.2, the first cavity 70.1 being located inside the partition tube 62 and being delimited by the partition tube 62 and a first layer, from either the acoustically resistive layer 54 or the reflective layer 56, and the second cavity 70.2 being located outside the partition tube 62 and being delimited by the walls 58.1 to 58.6 of the cellular structure 52; the partition tube 62, the reflective layer 56 and the acoustically resistive layer 54, and the first and second cavities 70.1, 70.2 communicating via the second tube section 66. Thus one of the cavities 70.1, 70.2 forms a first resonator of the Helmholtz type which is capable of attenuating the low-frequency sound waves. In addition, the other cavity 70.1, 70.2 forms a second resonator of the quarter-wave type which is capable of attenuating the high-frequency sound waves.

This solution makes it possible to obtain an acoustic absorption structure which is configured to attenuate sound waves on a wide frequency band or on several frequency bands.

According to the embodiment which is visible in FIG. 4, the first cavity 70.1 forms a first resonator of the Helmholtz type which is capable of attenuating the low-frequency sound waves. In addition, the second cavity 70.2 forms a second resonator of the quarter-wave type which is capable of attenuating the high-frequency sound waves.

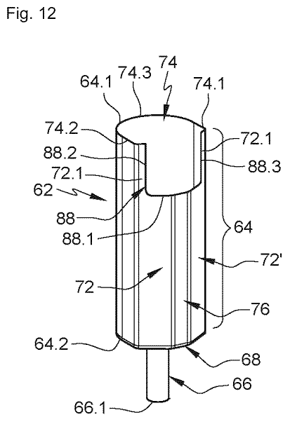

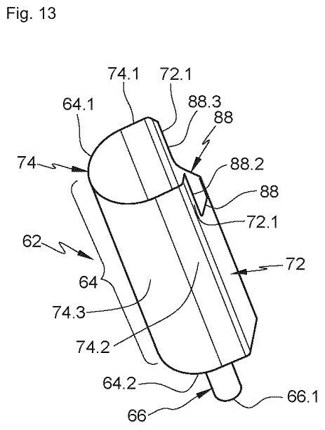

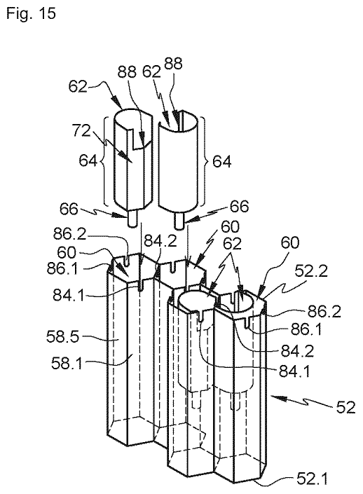

According to a particularity of the disclosure herein which is visible in FIGS. 12 to 16, the first tube section 64 of the partition tube 62 comprises at least two flat sides 72, 72′ which are placed against at least first and second adjacent fixing walls 58.1, 58.2, from amongst the walls 58.1 to 58.6 of the cell 60, and fixed thereto and at least one lateral wall 74 which is remote from the other walls 58.3 to 58.6 of the cell 60, called the remote walls.

Each flat side 72, 72′ is fixed to a fixing wall 58.1, 58.2 by any appropriate means, such as by adhesive bonding, welding, stapling or the like, as a function of the type of elements to be assembled.

According to one configuration, each flat side 72, 72′ extends over the entire height of the first tube section 64 from the first end 64.1 to the second end 64.2.

According to one embodiment, each wall 58.1 to 58.6 of the cell 60 comprises a first end edge 58a which is located in the region of the second face 52.2 of the cellular structure 52, a second end edge 58b which is located in the region of the first face 52.1 of the cellular structure 52 and lateral edges 58c, 58d connecting the first and second end edges 58a, 58b. The first and second fixing walls 58.1, 58.2 are connected by a common lateral edge 58c.

Since the cell 60 has a hexagonal cross section, the fixing walls 58.1, 58.2 form an angle of 120° therebetween. In addition, the flat sides 72, 72′ form with one another an angle in the order of 120° so as to be placed against the first and second fixing walls 58.1, 58.2. Each flat side 72, 72′ has a width of less than that of the corresponding first or second fixing wall 58.1, 58.2.

Each lateral wall 74 is spaced apart from the remote walls 58.3 to 58.6 of the cell 60 by a substantially uniform distance. According to one embodiment, the lateral wall 74 comprises two planar parts 74.1, 74.2 which are parallel to one another and connected to the flat sides 72, 72′ and a curved part 74.3 connecting the two planar parts 74.1, 74.2.

According to one arrangement, the curved part 74.3 of the lateral wall 74 is a cylindrical portion having an axis coinciding with the first axis A64 of the first tube section 64.

Each flat side 72, 72′ forms an angle in the order of 120° with the planar part 74.1, 74.2 of the adjacent lateral wall 74.

The planar and curved parts 74.1, 74.2, 74.3 of the lateral wall 74 are spaced apart from the third, fourth, fifth and sixth remote walls 58.3 to 58.6, opposing the planar and curved parts, by a distance of between 5% and 50% of the diameter D60 of the circle inscribed in the first section S1.

According to one configuration, the partition tube 62 comprises a spacer zone 76 separating the two flat sides 72, 72′, spaced apart from the lateral edge 58c which is common to the first and second fixing walls 58.1, 58.2. According to one arrangement, this spacer zone 76 is planar and extends over the entire height of the first tube section 64, from the first end 64.1 to the second end 64.2. The spacer zone 76 forms with each flat side 72, 72′ an angle in the order of 150° and has a width (dimension taken perpendicularly to the first end 64.1) in the order of several millimeters, less than half of the width of a flat side 72, 72′.

According to the disclosure herein, the partition tube 62 is connected to at least two fixing walls 58.1, 58.2 of the cell 60 in which the partition tube 62 is positioned, and at most to four remote walls 58.2 to 58.6. Thus the cell 60 comprises at least first and second adjacent fixing walls 58.1, 58.2 to which the partition tube 62 is connected and at least two remote walls 58.3 to 58.6 which are spaced apart from the partition tube 62. Since the partition tube 62 is not connected to all of the walls 58.1 to 58.6 of the cell 60, the cellular structure 52 preserves a certain degree of flexibility. Thus the cellular structure 52 preserves a degree of flexibility which enables it to be shaped. The flexibility of the cellular structure 52 is all the greater, the lower the number of walls to which the partition tube 62 is connected.

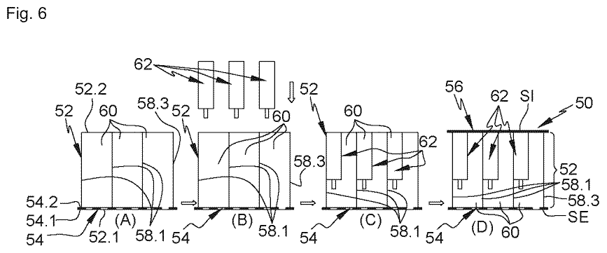

According to a first embodiment which is visible in FIG. 6, a method of manufacturing an acoustic absorption structure comprises a step of producing a cellular structure 52 comprising first and second planar faces 52.1, 52.2, a step of positioning the acoustically resistive layer 54 on the first face 52.1 of the cellular structure 52 as illustrated in the part (A) of FIG. 6, a step of inserting each partition tube 62 into a cell 60 as illustrated in the part (B) of FIG. 6, a step of fixing the partition tube 62 inserted into the cell 60 to at least two fixing walls 58.1, 58.2 of the cell 60 as illustrated in the part (C) of FIG. 6, a possible step of shaping the cellular structure 52 and a step of positioning the reflective layer 56 on the second face 52.2 of the cellular structure 52 as illustrated in the part (D) of FIG. 6.

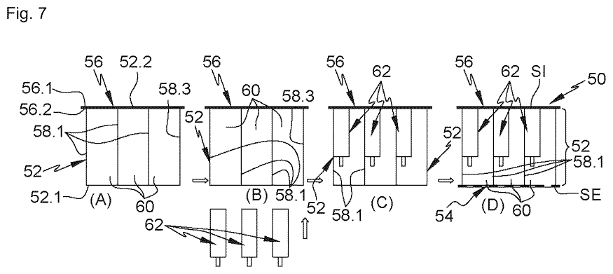

According to a second embodiment which is visible in FIG. 7, a method of manufacturing an acoustic absorption structure comprises a step of producing a cellular structure 52 comprising first and second planar faces 52.1, 52.2, a step of positioning the reflective layer 56 on the second face 52.2 of the cellular structure 52 as illustrated in the part (A) of FIG. 7, a step of inserting each partition tube 62 into a cell 60 as illustrated in the part (B) of FIG. 7, a step of fixing the partition tube 62 inserted into the cell 60 to at least two fixing walls 58.1, 58.2 of the cell 60 as illustrated in the part (C) of FIG. 7, a possible step of shaping the cellular structure 52 and a step of positioning the acoustically resistive layer 54 on the first face 52.1 of the cellular structure 52 as illustrated in the part (D) of FIG. 7.

According to a further embodiment, a method of manufacturing an acoustic absorption structure comprises a step of producing a cellular structure 52 comprising first and second planar faces 52.1, 52.2, a step of inserting each partition tube 62 into a cell 60, a step of fixing the partition tube 62 inserted into the cell 60 to at least two fixing walls 58.1, 58.2 of the cell 60, a step of shaping the cellular structure 52 and steps of positioning an acoustically resistive layer 54 and a reflective layer 56 produced after the step of fixing the partition tubes 62 in the cells 60 of the cellular structure 52.

The step of inserting the partition tubes 62 can be carried out individually, one partition tube after another partition tube, or in a plurality thereof, a plurality of partition tubes being simultaneously inserted. The step of inserting the partition tubes 62 can be mechanized and/or produced before or after the shaping step.

According to one operating mode, during the step of fixing each partition tube 62, at least one centring element is used to hold the partition tube 62 spaced apart from the remote walls 58.3 to 58.6.

According to one embodiment, the cellular structure 52 can be metallic or made of a composite material. The partition tubes 62 can be metallic, made of a composite material or made of a plastics material.

When they are made of plastics material, the partition tubes 62 can be produced by a blow-moulding method, injection-moulding method or stamping method, for example.

According to one operating mode, the method of manufacturing comprises a step of cutting out at least one partition tube in a single piece 78.

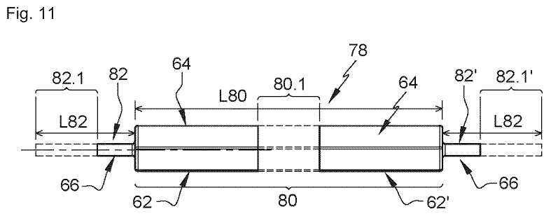

Thus, as illustrated in FIG. 11, two partition tubes 62, 62′ can be cut out from the same piece 78 which is produced in a single piece. This piece 78 comprises a central section 80 which has an identical cross section to that of the first tube section 64 of each partition tube 62, 62′, and two secondary sections 82, 82′ positioned on either side of the central section 80 and extending the central section, each of the secondary sections 82, 82′ having an identical cross section to that of the second tube section 66 of each partition tube 62, 62′. The central section 80 has a length L80 which is greater than the sum of the lengths of two first tube sections 64. Thus this central section 80 comprises two first tube sections 64 of two partition tubes 62, 62′ and an excess length 80.1. In addition, each secondary section 82, 82′ has a length L82, L82′ which is greater than that of the second tube section 66 of the partition tubes 62, 62′. Thus each secondary section 82, 82′ comprises a second tube section 66 of a partition tube 62, 62′ and an excess length 82.1, 82.1′. According to this embodiment, it is possible to cut out two partition tubes 62, 62′ from a single piece 78 which is produced in a single piece, each thereof having a first tube section 64 with a suitable length which can be different from one partition tube to another. Moreover, it is possible to cut out the two secondary sections 82, 82′ in order to adjust the length of the second tube section 66 of each of the partition tubes 62, 62′.

Naturally, the disclosure herein is not limited to this production method for the partition tubes.

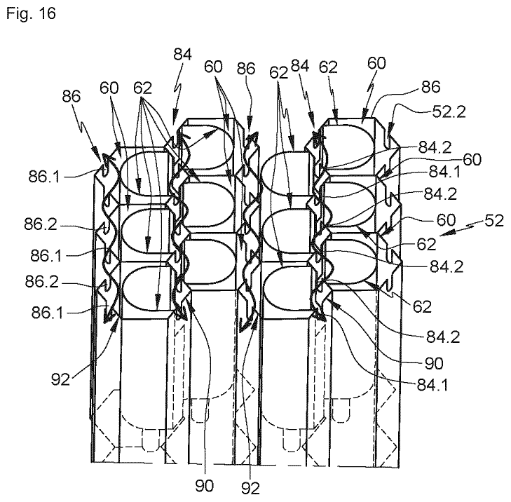

According to one feature of the disclosure herein which is visible in FIG. 16, the acoustic absorption structure 50 comprises at least one first drainage network 84 which is secant with the first cavity 70.1 located inside the partition tube 62 which is positioned in a given cell 60, and at least one second drainage network 86 which is secant with the second cavity 70.2 located outside the partition tube 62, between the partition tube 62 and the cell 60.

The first drainage network 84 comprises, in the region of a cell 60, first and second openings 84.1, 84.2 passing through the first and second fixing walls 58.1, 58.2. In addition, the second drainage network 86 comprises, in the region of the cell 60, third and fourth openings 86.1, 86.2, passing through third and fourth walls 58.3, 54.4 opposing the first and second fixing walls 58.1, 58.4. The first, second, third and fourth openings 84.1, 84.2, 86.1, 86.2 are located in the region of the first or second end edges 58a, 58b of the walls 58.1 to 58.6, the first end 64.1 of the first tube section 64 of the partition tube 62 being positioned in the region thereof.

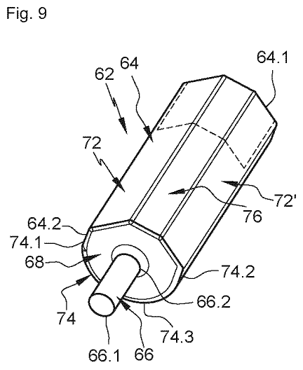

In order to ensure a continuity between the first and second openings 84.1, 84.2, the partition tube 62 comprises at least one notch 88 which extends from the first end 64.1 of the first tube section 64, the notch 88 being configured to open up at least the first and second openings 84.1, 84.2 when the partition tube 62 is fixed to the first and second fixing walls 58.1, 58.2. According to a first configuration, the partition tube 62 comprises two notches, one for each of the first and second openings 84.1, 84.2. According to a second configuration which is visible in FIGS. 9 and 12 to 16, the partition tube 62 comprises a single notch 88 which opens up the first and second openings 84.1, 84.2 and extends over the two flat sides 72, 72′ and the spacer zone 76. This notch 88 is delimited by a first edge 88.1 which is substantially parallel to the first end 64.1 of the first tube section 64, and second and third edges 88.2, 88.3, which are substantially perpendicular to the upper end 64.1, connecting the first end 64.1 and the first edge 88.1, in the vicinity of the two planar parts 74.1, 74.2 of the lateral wall 74 and remote from the lateral wall 74. The notch 88 is remote from the lateral wall 74, in particular the two planar parts 74.1, 74.2 of the lateral wall 74. Thus the flat sides 72, 72′ each comprise a strip of material 72.1 which extends to the first end 64.1 of the first tube section 64 so that the two strips of material 72.1 of the flat sides 72, 72′ are placed and fixed against the first and second fixing walls 58.1, 58.2 up to the first end 64.1 on either side of the notch 88.

The fact that the partition tube 62 is connected to the first and second fixing walls 58.1, 58.2 and comprises at least one notch 88 opening up the first and second openings 84.1, 84.2, provided in the region of the first and second fixing walls 58.1, 58.2, makes it possible to isolate the first drainage network 84 from the second drainage network 86.

According to one embodiment, in a given area, each cell 60 of the cellular structure 52 comprises a partition tube 62. The first and second fixing walls 58.1, 58.2 are connected to one another so as to form, when viewed from above, at least one first broken line 90. At the same time, the third and fourth walls 58.3, 58.4 are connected to one another so as to form, when viewed from above, at least one second broken line 92 which is spaced apart from the first broken line 90 and connected thereto by fifth and sixth walls 58.5, 58.6 which are parallel to one another and without notches.

The partition tubes 62 are positioned on either side of the first broken line 90 and connected to the first and second fixing walls 58.1, 58.2. Thus each of the first and second fixing walls 58.1, 58.2 is connected to two partition tubes 62 positioned on either side of the fixing wall 58.1, 58.2.

According to this embodiment, the cellular structure 52 comprises a plurality of first drainage networks 84, each thereof being positioned on either side of a first broken line 90 and comprising first and second openings 84.1, 84.2 provided in the region of the first and second fixing walls 58.1, 58.2 which form the first broken line 90, and the first cavities 70.1 of the partition tubes 62 connected to the first and second fixing walls 58.1, 58.2 which form the first broken line 90. In addition, the cellular structure 52 comprises a plurality of second drainage networks 86, each thereof being positioned on either side of a second broken line 92 and comprising third and fourth openings 86.1, 86.2 provided in the region of third and fourth walls 58.3, 58.4 which form the second broken line 92, and the second cavities 70.2 of the cells 60 positioned on either side of the second broken line 92.

According to one operating mode, the method of manufacturing an acoustic cellular structure 52 comprises at least one step of grooving in order to produce the openings 84.1, 84.2, 86.1, 86.2 of the first and second drainage networks 84, 86. This step of grooving is implemented before the steps of inserting the partition tubes 62 and the steps of positioning the acoustically resistive layer 54 and the reflective layer 56.

Naturally the disclosure herein is not limited to these embodiments of the first and second drainage networks 84, 86.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An acoustic absorption structure comprising:
at least one cellular structure interposed between an acoustically resistive layer and a reflective layer;
the cellular structure comprising a first face in contact with the acoustically resistive layer, a second face in contact with the reflective layer and a plurality of cells, each leading to a region of the first and second faces, and each cell being delimited by walls;
the cellular structure comprising at least one partition tube positioned in one of the cells and comprising a first tube section which extends between first and second ends and has a first section between the first and second ends, and a second tube section which extends between the first and second ends and has a second section between the first and second ends;
the second section being smaller than the first section and a joining wall connecting the second ends of the first and second tube sections;
the first end of the first tube section being sealed by a first layer, from either the acoustically resistive layer or the reflective layer, and the first end of the second tube section being spaced apart from a second layer, which is different from the first layer, from either the acoustically resistive layer or the reflective layer;
the first tube section of the partition tube comprising at least two flat sides and at least one lateral wall, the walls which delimit the cell into which the partition tube is inserted comprising at least first and second planar fixing walls against which the flat sides of the partition tube are placed and fixed, and at least two remote walls which are spaced apart from the lateral wall of the partition tube.

2. The acoustic absorption structure according to claim 1, wherein the acoustic absorption structure comprises at least one first drainage network which comprises first and second openings passing through the first and second fixing walls and at least one second drainage network which comprises third and fourth openings passing through third and fourth walls opposing the first and second fixing walls.

3. The acoustic absorption structure according to claim 2, wherein each wall of the cell in which the partition tube is positioned comprises first and second end edges located in the region of the first and second faces of the cellular structure and wherein the first, second, third and fourth openings are located in a region of the first or second end edges of the walls, the first end of the first tube section of the partition tube being positioned in the region thereof.

4. The acoustic absorption structure according to claim 1, wherein the partition tube comprises at least one notch which extends from the first end of the first tube section, the notch being configured to open up at least the first and second openings when the partition tube is fixed to the first and second fixing walls.

5. The acoustic absorption structure according to claim 4, wherein the partition tube comprises a single notch which opens up the first and second openings.

6. The acoustic absorption structure according to claim 5, wherein the notch is delimited by a first edge and second and third edges, connecting the first edge and the upper end of the first tube section, remote from the lateral wall.

7. The acoustic absorption structure according to claim 1, wherein the first and second fixing walls are connected by a common lateral edge and wherein the partition tube comprises a spacer zone, separating the two flat sides, spaced apart from the lateral edge which is common to the first and second fixing walls.

8. The acoustic absorption structure according to claim 1, wherein each flat side extends from the first end to the second end of the first tube section.

9. The acoustic absorption structure according to claim 1, wherein the lateral wall comprises two planar parts which are parallel to one another and connected to the flat sides and a curved part connecting the two planar parts, the planar and curved parts of the lateral wall being spaced apart from the walls of the cell in which the partition tube is positioned.

10. The acoustic absorption structure according to claim 1, wherein, in a given area, each cell of the cellular structure comprises a partition tube which is connected to the first and second fixing walls, which is passed through by the first and second openings, and spaced apart from third and fourth walls opposing the first and second fixing walls which are passed through by third and fourth openings, wherein the first and second fixing walls of the cells are connected to one another to form, when viewed from above, at least one first broken line, the partition tubes being positioned on either side of the first broken line and connected to the first and second fixing walls, and wherein the third and fourth walls of the cells are connected to one another to form, when viewed from above, at least one second broken line which is spaced apart from the first broken line.
